(19) United States
(12) Patent Application Publication
(10) Pub. No.: US 2026/0301600 A1
(43) Pub. Date: Oct. 1, 2026

(54) AUDIO VISUAL LANGUAGE LEARNING

(71) Applicant: Elise Michele-Ange Laura Carpenter, Raleigh, NC (US)

(72) Inventor: Elise Michele-Ange Laura Carpenter, Raleigh, NC (US)

(21) Appl. No.: 19/092,122

(22) Filed: Mar. 27, 2025

(51) Int. Cl. G09B 19/06; G09B 5/06

(52) U.S. Cl. CPC G09B 19/06; G09B 5/065

(57) ABSTRACT

The present invention for language learning combines proper spoken language with a music staff or a graph to represent stress, pitch, rhythm and cadence.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a digital visual mapping system for learning language. In particular, sheet music or graphs are used to visually illustrate pitch, rhythm, stress and cadence or a word or phrase when combined with audio recording of the word or phrase.

### Description of Related Art

The learning of additional languages is more and more widespread. In addition to in person language learning, several online or app-based language learning opportunities exist.

Language apps such as Duolingo or Babble provide speakers with an audio recording of speech. Many such apps review your speaking, but don't explain what's wrong with words you didn't say correctly. They also don't grade the nuances of speech for the words it says you got right.

### BRIEF SUMMARY OF THE INVENTION

The present invention relates to a system for visually seeing the nuances of spoken word during language learning. It is discovered that mapping of a language to sheet music or a graph provides a visual representation of intonation, tone, rhythm, timing, cadence, and word or syllable stress.

Accordingly, in one embodiment, there is a visual and audio system for the enhancement of language learning comprising:
a) a recording of a person speaking the language being learned; and
b) a graph or staff lines wherein at least one of intonation, tone, rhythm, timing, cadence, and syllable stress is represented on the staff or graph.

In another embodiment, there is an audio and visual method of enhancing language learning by a person comprising:
a) providing a professional speaking the language to be learned;
b) providing a graph or staff lines wherein at least one of intonation, tone, rhythm, timing, cadence, and syllable stress is represented on the staff or graph; and
c) wherein the graph or staff is compared to the professional speaking person learning the language.

### BRIEF DESCRIPTION OF THE DRAWINGS

FIG. 1 is musical staff lines wherein the notes correspond to speaking tones.

FIG. 2 is a graphic representation of a voice actor and 2 students speaking.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

It is further noted that the claims may be drafted to exclude any element which may be optional. As such, this statement is intended to serve as antecedent basis for use of such exclusive terminology as “solely”, “only” and the like in connection with the recitation of claim elements, or the use of a “negative” limitation.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. To the extent such publication may set out definitions of a term that conflict with the explicit or implicit definition of the present disclosure, the definition of the present disclosure controls.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “visual and audio system” refers to teaching a language to a person with both audio and visual representations of the speech pattern and sound of a language a person is trying to learn. A professional voice actor or other proper speaking individual of the desired language records words, sentences, conversations and the like. The recordings are translated into a visual map to be used along with the recorded pronunciation when trying to repeat what the professional says on a graph or musical staff. These represent key elements of one or more part of speech including:
Intonation. That is the rise and fall of pitch showing where the voice naturally lifts or drops for the words sentences and conversations including emphasis.
Tone. That is subtle variations in pitch that convey mood or intent.
Rhythm. The pattern of stressed and unstressed syllables which helps learners understand the actual flow of speech.
Timing. The duration of syllables and pauses to help understand the pacing of a conversation.
Cadence. The overall musicality and flow of the language.
Stress. The emphasis placed on specific syllables which can change meaning or focus within a sentence.

As used herein, the term “professional speaking the language” refers to a recording of someone speaking the desired language. A word, a phrase or the like is recorded. A professional or native speaker is ideal.

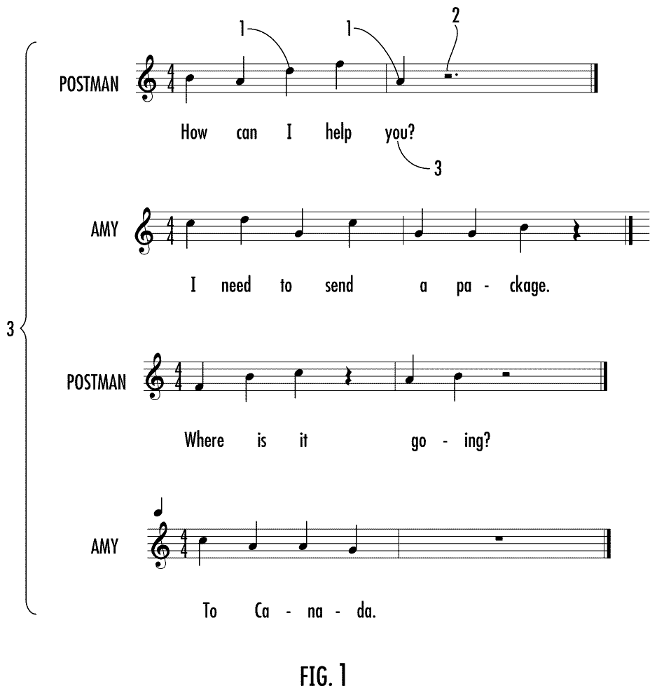

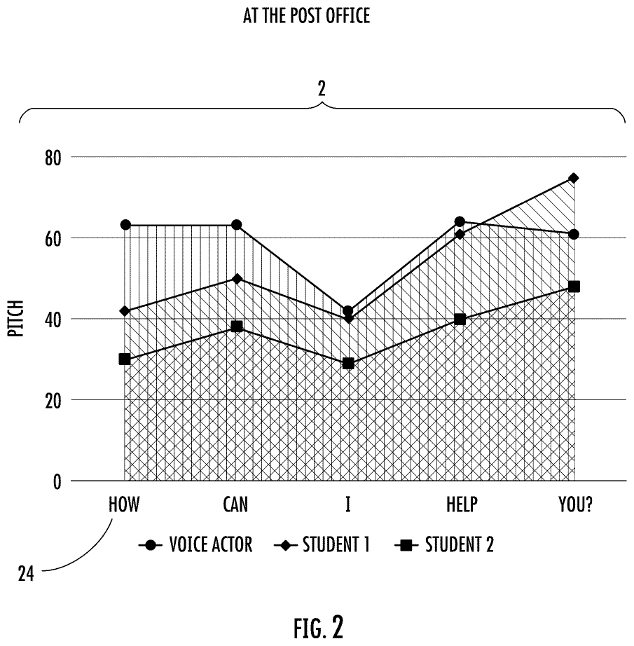

As used herein, the term “graph or staff lines” refers to visual placement of notes or the like which indicate changing pitch, duration, timing, cadence, stress intonation, rhythm and the like. See examples of both in FIG. 1 and FIG. 2.

As used herein, the term “compared” refers to the person learning the language using both audio and visual using the comparison to comprehend how to speak whatever word or phrase is being used.

### DRAWINGS

Now referring to the drawings, FIG. 1 is a representation of a conversation of two people from a recording with the pitch decided by where the note 1 is or where rest bars 2 are. In this figure, the language being learned is English 3.

FIG. 2 is an example of a graph 2 which compares a voice actor 21 to a first 22 and second 23 student speaking the sentence 24 spoken by the voice actor 21.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A visual and audio system for the enhancement of language learning by a person comprising:
a) a recording of a person speaking the language being learned; and
b) a graph or staff lines wherein at least one of intonation, tone, rhythm, timing, cadence, and syllable stress is represented on the staff or graph.

2. An audio and visual method of enhancing language learning by a person comprising:
a) providing a professional speaking the language to be learned;
b) providing a graph or staff lines wherein at least one of intonation, tone, rhythm, timing, cadence, and syllable stress is represented on the staff or graph; and
c) wherein the graph or staff is compared to the professional speaking person learning the language.
